(19) United States
(12) Patent Application Publication
(10) Pub. No.: US 2017/0002781 A1
(43) Pub. Date: Jan. 5, 2017

(54) APPARATUS FOR REMOVING O-RINGS FROM FUEL INJECTORS

(71) Applicant: Caterpillar Inc., Peoria, IL (US)

(72) Inventor: Alberto Ramos Ramos, Nuevo Laredo (MX)

(73) Assignee: Caterpillar Inc., Peoria, IL (US)

(21) Appl. No.: 15/264,665

(22) Filed: Sep. 14, 2016

(51) Int. Cl. F02M 61/16; B26D 5/08; B26D 1/00; B26D 7/01; B26D 7/24; F02M 37/00; B26D 5/12

(52) U.S. Cl. CPC F02M 61/168; F02M 37/0017; B26D 5/086; B26D 5/12; B26D 7/01; B26D 7/24; B26D 1/0006; B26D 2001/006

(57) ABSTRACT

An apparatus for removing O-rings from a device is disclosed. The apparatus includes a first actuator assembly that is adapted to modulate at least two first cutting members via at least two pistons. The apparatus includes a second actuator assembly that is adapted to modulate at least two second cutting member via at least two pistons. The apparatus further includes a receiver module sandwiched between the first actuator assembly and the second actuator assembly. The receiver module is adapted to secure the device to remove the O-rings. The receiver module is adapted to be replaced according to a model of the device. The at least two first cutting members and the at least two second cutting members operate in a complementary manner and in synchronization with each other to perform at least two hitting strokes per cycle for an efficient breakage of the O-rings.

### TECHNICAL FIELD

The present disclosure relates to fuel injectors, and more specifically, to an apparatus for removing O-rings from fuel injectors.

### Background

O-rings are widely utilized across various devices, for example, fuel injectors of an engine. Generally, the O-rings are used between two circumferential joints to seal the joints along the circumference, from oil, fuel or coolant, these O-Rings are manufactured from elastomeric materials. The O-rings are in a toroidal shape with a round cross-section that facilitates them to be seated in a groove and compressed during assembly between two or more components, and thereby creates a seal at an interface. For example, an O-ring may seal an injector tip with an intake manifold. With time, the O-rings tend to wear out and cause issues with the fuel injectors. Therefore, the fuel injectors may require timely maintenance for proper operation of the engine. As a part of maintenance, the O-rings of the fuel injectors may be required to be changed/disassembled, due to wear and tear of the O-rings. The removal of the O-rings from the fuel injectors is a critical process.

There exist various conventional techniques for removing the O-rings from the fuel injectors. Dental picks are utilized for removing the O-rings from the fuel injectors. However, the dental picks may damage the component where the O-rings sit, they may also be cumbersome to operate. Other conventional technique utilizes a cutting tool for removing the O-rings from the fuel injectors. However such cutting tool is limited to remove the O-rings from a specific model of the fuel injectors. As a result, there are limitations to use such cutting tool on a variety of models of the fuel injectors.

PCT Patent Publication Number WO2011/112390A1 discloses a cutter that includes a cutting jaw, linkage and a driver for cutting a thru-fastener or a ring from a device. The cutting jaw is configured to cut the thru-fastener from the device. The linkage is coupled to the cutting jaw and configured to convey a force to move the cutting jaw. The driver coupled to the linkage and configured to apply the force to the linkage. Such cutters are limited to remove the O-rings for a specific model of fuel injectors, and hence are not cost effective.

Therefore, there is a need for an improved apparatus for removing the O-rings from the fuel injectors that can cover several injector families without adjustments to working pressures or operating lengths.

### SUMMARY OF THE DISCLOSURE

In one aspect of the present disclosure, an apparatus for removing O-rings from a device, i.e. a fuel injector is disclosed. The apparatus includes a first actuator assembly that is adapted to modulate at least two first cutting members. The first actuator assembly has at least two pistons for modulating the at least two first cutting members. The apparatus includes a second actuator assembly that is adapted to modulate at least two second cutting members. The second actuator assembly has at least two pistons for modulating the at least two second cutting members. The apparatus further includes a receiver module sandwiched between the first actuator assembly and the second actuator assembly. The receiver module is adapted to secure the device to remove the O-rings. The receiver module is adapted to be replaced according to the injector model. The at least two first cutting members and the at least two second cutting members operate in a complementary manner and in synchronization with each other to perform at least two hitting strokes per cycle for an efficient cutting of the O-rings. If any of the two cutting members is not required, the pistons of the actuator do not need to be changed as there will be no length to travel, stopping at the wall of the receiver. In the same manner, if, more cutting members are required, they may be placed in the receiver so that either the first or second actuator operates the additional cutter.

Other features and aspects of this disclosure will be apparent from the following description and the accompanying drawings.

### BRIEF DESCRIPTION OF THE DRAWINGS

FIG. 1 is a perspective view of a fuel injector with O-rings, in accordance with the concepts of the present disclosure;

FIG. 2 is a perspective view of an apparatus adapted to secure the fuel injector, in accordance with the concepts of the present disclosure;

FIG. 3 is a perspective view of the apparatus for removing the O-rings from the fuel injector of FIG. 1, in accordance with the concepts of the present disclosure; and

FIG. 4 is a top view of a receiver module showing first and second cutting members, in accordance with the concepts of the present disclosure.

### DETAILED DESCRIPTION

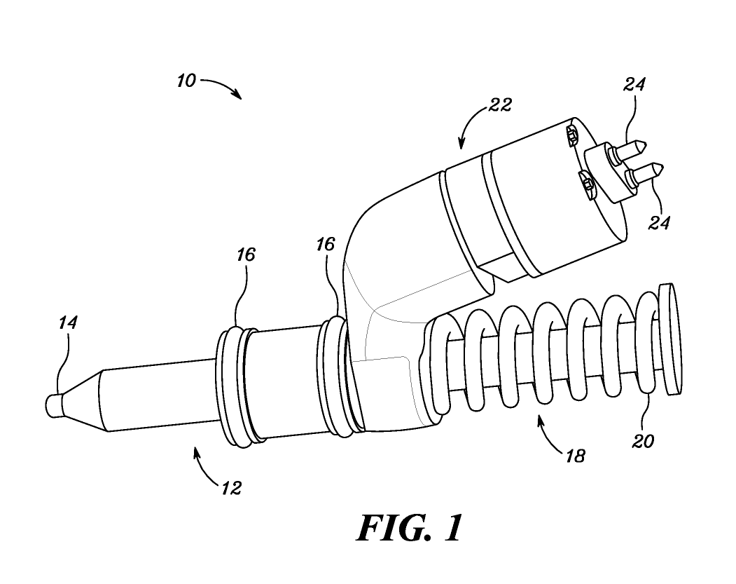

Referring to FIG. 1, an exemplary fuel injector 10 is illustrated. In general, the fuel injector 10 is utilized to deliver fuel to a combustion chamber of an engine (not shown). The fuel injector 10 includes a first end 12 having a tip portion 14. In an embodiment, the fuel injector 10 has two O-rings 16. It will be apparent to one skilled in the art that the fuel injector 10 may also include more than two O-rings 16 depending on type of the fuel injector 10 without departing from the meaning and scope of the disclosure. The fuel injector 10 further includes a second end 18 having a spring member 20. The fuel injector 10 further includes a third portion 22 having a pin member 24 for receiving power to operate the fuel injector 10. During continuous operation of the engine, the O-rings 16 of the fuel injector 10 may get damaged due to extreme temperature, and therefore the O-rings 16 require periodic replacement.

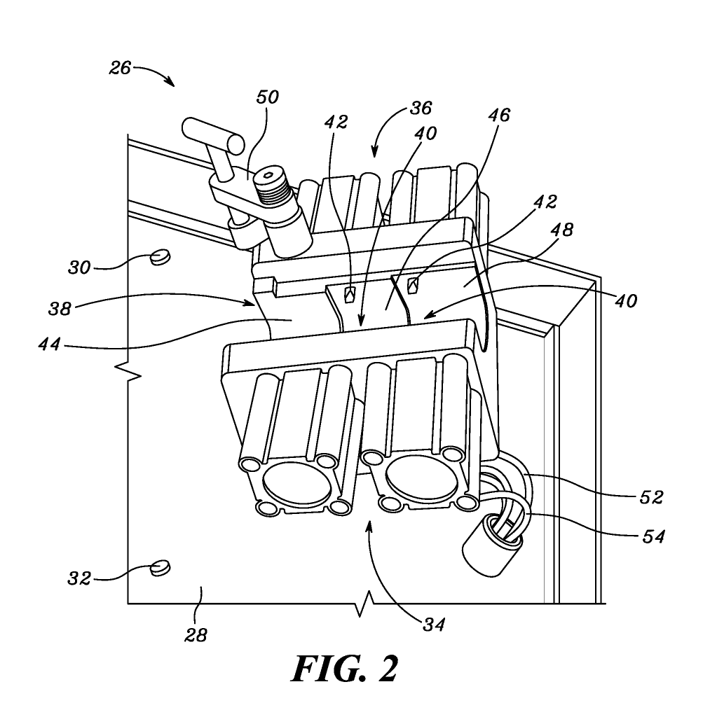

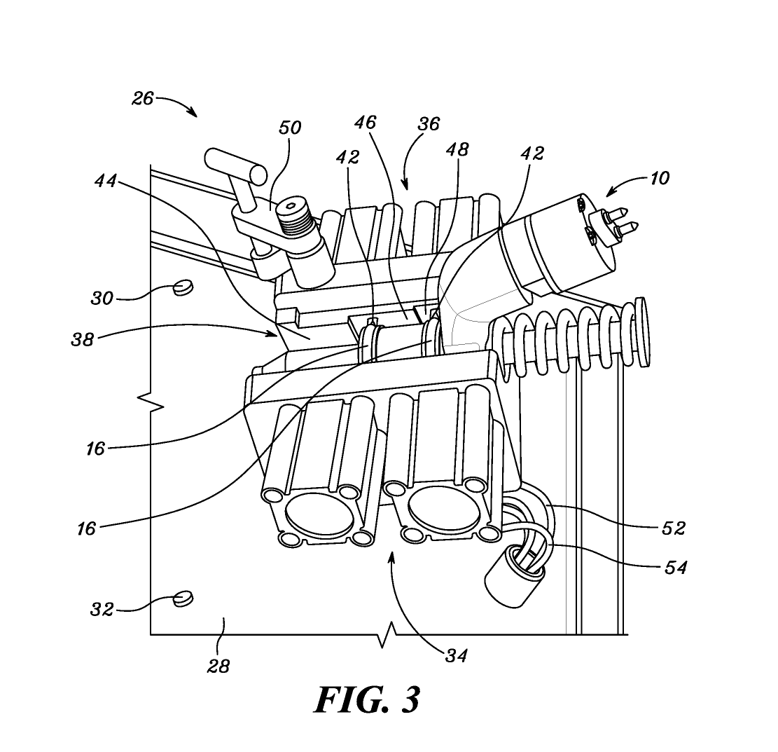

Referring to FIGS. 2 and 3, a perspective view of an apparatus 26 is shown. The apparatus 26 is used for removing the O-rings 16 from a device, i.e. the fuel injector 10 (shown in FIG. 3 and hidden in FIG. 2). The apparatus 26 is fixed on a platform 28 at a height suitable for efficient operation of the apparatus 26 by an operator. The apparatus 26 is activated or started by engaging a first switch 30 and a second switch 32 on each side of the apparatus 26. Each of the first switch 30 and the second switch 32 is a button or switch for activating the apparatus 26. The apparatus 26 is started only when both the first switch 30 and the second switch 32 are engaged simultaneously. The first switch 30 and the second switch 32 are spaced sufficiently far apart from one another to require the operator to use both hands to start the apparatus 26. Further, the apparatus 26 may also have an emergency button (not shown) that is operated by the operator for immediately halting the operations of the apparatus 26 during emergency.

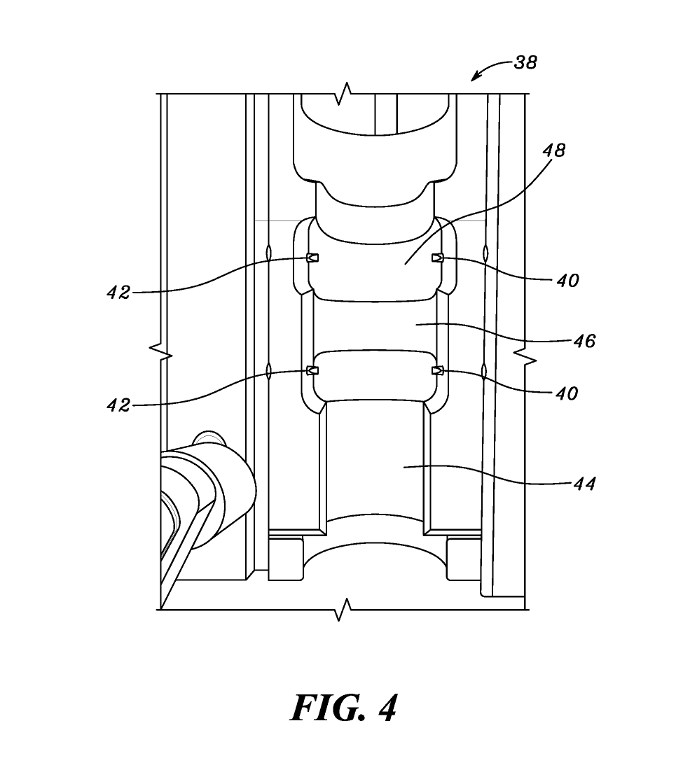

The apparatus 26 includes a first actuator assembly 34, a second actuator assembly 36, and a receiver module 38. The first actuator assembly 34 modulates a number of first cutting members 40 (shown in FIG. 4). The first actuator assembly 34 uses a number of pistons (not shown) for modulating the first cutting members 40. It will be apparent to one skilled in the art that the first actuator assembly 34 may also include additional first cutting members 40 depending on the number of O-rings 16 in the fuel injector 10 without departing from the meaning and scope of the disclosure. The second actuator assembly 36 modulates a number of second cutting members 42 (shown in FIG. 4). The second actuator assembly 36 uses a number of pistons (not shown) for modulating the second cutting members 42. The term “modulation” implies actuating or operating or triggering or energizing the first cutting members 40 and the second cutting members 42 in a manner that the first cutting members 40 and the second cutting members 42 are protruded out to hit the O-rings 16. The first cutting members 40 and the second cutting members 42 may have a desired shape, material strength, tip structure that may efficiently cut the O-rings 16 from the fuel injector 10. It will be apparent to one skilled in the art that the second actuator assembly 36 may also include additional second cutting members 42 depending on the number of O-rings 16 in the fuel injector 10 without departing from the meaning and scope of the disclosure. In an embodiment, the first actuator assembly 34 and the second actuator assembly 36 are pneumatically controlled. In another embodiment, the first actuator assembly 34 and the second actuator assembly 36 are mechanically driven, electrically driven, or hydraulically driven without departing from the meaning and scope of the disclosure.

The apparatus 26 further includes the receiver module 38 that is sandwiched between the first actuator assembly 34 and the second actuator assembly 36. In some embodiments, receiver module 38 is coupled to the first actuator assembly 34 and the second actuator assembly 36 by screws, bolts, pins, or similar arrangements. The receiver module 38 secures the fuel injector 10, before actuating the apparatus 26 for removing the O-rings 16. The receiver module 38 includes alignment portions, i.e. a first alignment portion 44, a second alignment portion 46, a third alignment portion 48 to properly receive and align the fuel injector 10 within the receiver module 38 of the apparatus 26. It will be apparent to one skilled in the art that the receiver module 38 may have other alternate structure and alignment portions, i.e. the first alignment portion 44, the second alignment portion 46, the third alignment portion 48 to hold a variety of fuel injector 10 in the apparatus 26 without departing from the meaning and scope of the disclosure. The apparatus 26 may also include a holding tool 50, hoses 52, 54 for facilitating operations of the apparatus 26. The apparatus 26 further includes various other components such as, but not limited to, pneumatic controllers, electric circuits, that are not labeled in FIGS. 2 and 3 for the purpose of simplicity.

Referring to FIGS. 3 and 4, the fuel injector 10 is first placed within the receiver module 38 via the first alignment portion 44, the second alignment portion 46, and the third alignment portion 48. This arrangement facilitates a proper alignment of the fuel injector 10 within the receiver module 38 before the apparatus 26 is actuated. After proper securing of the fuel injector 10 within the receiver module 38, the apparatus 26 is operated by the operator with both hands by activating the first switch 30, and the second switch 32. As a result, the apparatus 26 modulates the first cutting members 40 and the second cutting members 42 to hit the O-rings 16, and thereby break the O-rings 16. The first cutting members 40 and the second cutting members 42 operate in a complementary manner and in synchronization with each other. The first cutting members 40 and the second cutting members 42 strike the O-rings 16 simultaneously from both sides for breaking the O-rings 16.

### INDUSTRIAL APPLICABILITY

The apparatus 26 provides a user friendly and efficient way to remove the O-rings 16 from the fuel injector 10. The apparatus 26 is ergonomically designed to offer comfort and efficiency to the operator, while operating the apparatus 26. The apparatus 26 has the receiver module 38 that is easily replaceable according to the models of the fuel injector 10, and hence the apparatus 26 offers a cost effective solution.

The apparatus 26 has the first switch 30, and the second switch 32 on each side of the apparatus 26 that are operated using both hands to activate the apparatus 26, and therefore the apparatus 26 offers safety to the operator. The first cutting members 40 and the second cutting members 42 perform at least two hitting strokes per cycle for efficient breakage of the O-rings 16. The first cutting members 40 and the second cutting members 42 are energized at least two times to strike on the O-rings 16 on a single activation of the apparatus 26. The apparatus 26 is an effective, easy to use, and accurate solution for removing the O-rings 16 from the fuel injector 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An apparatus for removing O-rings from a device, the apparatus comprising:
a first actuator assembly adapted to modulate at least two first cutting members, the first actuator assembly having at least two pistons for modulating the at least two first cutting members;
a second actuator assembly adapted to modulate at least two second cutting member, the second actuator assembly having at least two pistons for modulating the at least two second cutting members; and
a receiver module sandwiched between the first actuator assembly and the second actuator assembly, the receiver module is adapted to secure the device to remove the O-rings, the receiver module is adapted to be replaced according to a model of the device;
wherein the at least two first cutting members and the at least two second cutting members operate in a complementary manner and in synchronization with each other to perform at least two hitting strokes per cycle for an efficient breakage of the O-rings.

2. The apparatus of claim 1, wherein the device being a fuel injector of an engine.

3. The apparatus of claim 1, wherein the first actuator assembly and the second actuator assembly being pneumatically controlled.

4. The apparatus of claim 1, wherein the first actuator assembly and the second actuator assembly being operator by a first switch and a second switch on each side of the apparatus that are operated simultaneously.

5. The apparatus of claim 1, wherein the apparatus is fixed on a platform for efficient operation of the apparatus.
